(19) United States
(12) Patent Application Publication
(10) Pub. No.: US 2014/0138275 A1
(43) Pub. Date: May 22, 2014

(54) AUTOMATIC POWER-UP FROM SALES PACKAGE

(71) Applicant: NOKIA CORPORATION, Espoo (FI)

(72) Inventors: Birgir Magnusson, Paippinen (FI); Juhani Valdemar Kari, Lieto (FI); Timo Tapani Toivola, Turku (FI)

(73) Assignee: NOKIA CORPORATION, Espoo (FI)

(21) Appl. No.: 13/682,180

(22) Filed: Nov. 20, 2012

(51) Int. Cl. B65D 85/00; H04M 1/02

(52) U.S. Cl. CPC B65D 85/00; H04M 1/0202
USPC 206/459.1; 455/566

(57) ABSTRACT

A package having a first part configured for supporting an apparatus and a second part configured to fit on or around the first part for closing the package. The first part and the second part are configured to be movable relative to each other and the package comprises an element for generating a signal in response to the first part and the second part being moved from a closed position to an open position. The apparatus comprises a display, a processor, and a sensing element. The processor is configured to cause detecting the signal with the sensing element, powering up the apparatus in response to the signal, and automatically displaying information on the display.

### TECHNICAL FIELD

The present invention generally relates to packaging of electronic devices. More particularly, though not exclusively, the invention relates to packaging of mobile phones.

### BACKGROUND ART

Mobile phones and/or smartphones are annually sold in vast amounts, in the scale of a billion phones. Each phone is typically packaged into a cardboard or plastic box with an arrangement to hold the phone and related accessories and with space for user instructions. The package is provided for transport, storage and display of products on sale as well as for providing purchasers and users with necessary information such as properties of the product in the package, and after purchase information on how to take the product in use.

### SUMMARY

According to a first example aspect of the invention there is provided a package comprising:

a first part configured for supporting an electronic device;

a second part configured to fit on or around the first part for closing the package and enclosing the electronic device therein; wherein

the first part and the second part are configured to be movable relative to each other from a closed position to an open position; and wherein

the package comprises an element for generating a signal in response to the first part and the second part being moved from the closed position to the open position.

The element for generating the signal may comprise a permanent magnet.

The element for generating the signal may comprise a near field communication, NFC, unit.

According to a second example aspect of the invention there is provided an apparatus comprising:

a display;

a processor; and

a sensing element; wherein

the processor is configured to cause
detecting a signal with the sensing element;
powering up the apparatus in response to the signal; and
automatically displaying information on the display.

The sensing element may comprise a reed relay.

The sensing element may comprise a mechanical switch.

The sensing element may comprise an optical sensor.

The element may comprise a magnetic sensor.

The display may comprise a touch sensitive display.

The processor may further be configured to cause, subsequent to powering up the apparatus, verifying that the powering up was intended.

The processor may further be configured to cause, subsequent to displaying the information, disabling the sensing element.

The processor may further be configured to cause activating a function of the apparatus in response to the signal.

The apparatus may comprise an electronic device.

The apparatus may comprise a smartphone or a mobile phone.

According to a third example aspect of the invention there is provided a method comprising:

moving a first part and a second part of a package relative to each other from a closed position to an open position; and
generating a signal in response to the first part and the second part being moved from the closed position to the open position.

The signal may be generated with a permanent magnet.

The signal may be generated with a near field communication, NFC, unit.

According to a fourth example aspect of the invention there is provided a method comprising:

detecting a signal with a sensing element;

powering up an apparatus in response to the signal; and

automatically displaying information on a display of the apparatus.

The sensing element may comprise a reed relay.

The sensing element may comprise a mechanical switch.

The sensing element may comprise an optical sensor.

The sensing element may comprise a magnetic sensor.

The display may comprise a touch sensitive display.

The method may further comprise, subsequent to powering up the apparatus, verifying that the powering up was intended.

The method may further comprise, subsequent to displaying the information, disabling the sensing element.

The method may further comprise activating a function of the apparatus in response to the signal

The apparatus may comprise an electronic device.

The apparatus may comprise a smartphone or a mobile phone.

According to a fifth example aspect of the invention there is provided a system comprising:

a package comprising
a first part configured for supporting an apparatus;
a second part configured to fit on or around the first part for closing the package and enclosing the apparatus therein; wherein
the first part and the second part are configured to be movable relative to each other from a closed position to an open position; and wherein
the package comprises an element for generating a signal in response to the first part and the second part being moved from the closed position to the open position; wherein

the apparatus comprises
a display;
a processor; and
a sensing element; wherein
   the processor is configured to cause
      detecting the signal with the sensing element;
      powering up the apparatus in response to the signal; and
      automatically displaying information on the display.

The element for generating the signal may comprise a permanent magnet.

The element for generating the signal may comprise a near field communication, NFC, unit.

The sensing element may comprise a reed relay.

The sensing element may comprise a mechanical switch.

The sensing element may comprise an optical sensor.

The sensing element may comprise a magnetic sensor.

The display may comprise a touch sensitive display.

The processor may further be configured to cause, subsequent to powering up the apparatus, verifying that the powering up was necessary.

The processor may further be configured to cause, subsequent to displaying the information, disabling the sensing element.

The apparatus may comprise an electronic device.

The apparatus may comprise a smartphone or a mobile phone.

According to a sixth example aspect of the invention there is provided a method comprising:

moving a first part and a second part of a package relative to each other from a closed position to an open position;

generating a signal in response to the first part and the second part being moved from the closed position to the open position;

detecting a signal with a sensing element;

powering up an apparatus in response to the signal; and

automatically displaying information on a display of the apparatus.

The signal may be generated with a permanent magnet.

The signal may be generated with a near field communication, NFC, unit.

The sensing element may comprise a reed relay.

The sensing element may comprise a mechanical switch.

The sensing element may comprise an optical sensor.

The sensing element may comprise a magnetic sensor.

The display may comprise a touch sensitive display.

The method may further comprise, subsequent to powering up the apparatus, verifying that the powering up was necessary.

The method may further comprise, subsequent to displaying the information, disabling the sensing element.

The apparatus may comprise an electronic device.

The apparatus may comprise a smartphone or a mobile phone.

According to a seventh example aspect of the invention there is provided a computer program product comprising computer code for causing performing the method of any example aspect of the invention, when executed by an apparatus.

According to an eighth example aspect of the invention there is provided a memory medium comprising the computer program of the seventh example aspect of the invention.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows an example of an environment in which example embodiments of the invention are applied;

FIG. 2 shows schematic block diagram of an apparatus according to an example embodiment of the invention;

FIG. 3 shows a schematic circuit diagram of an out-of-box unit according to an example embodiment of the invention;

FIG. 4 shows a flow chart of a method according to an example embodiment of the invention;

FIG. 5 shows a flow chart of a method according to an example embodiment of the invention;

FIG. 6a shows a schematic top view of a sales package according to an example embodiment;

FIG. 6b shows a schematic side view of a sales package according to an example embodiment; and

FIG. 7 shows an example of an environment in which example embodiments of the invention are applied.

### DETAILED DESCRIPTION

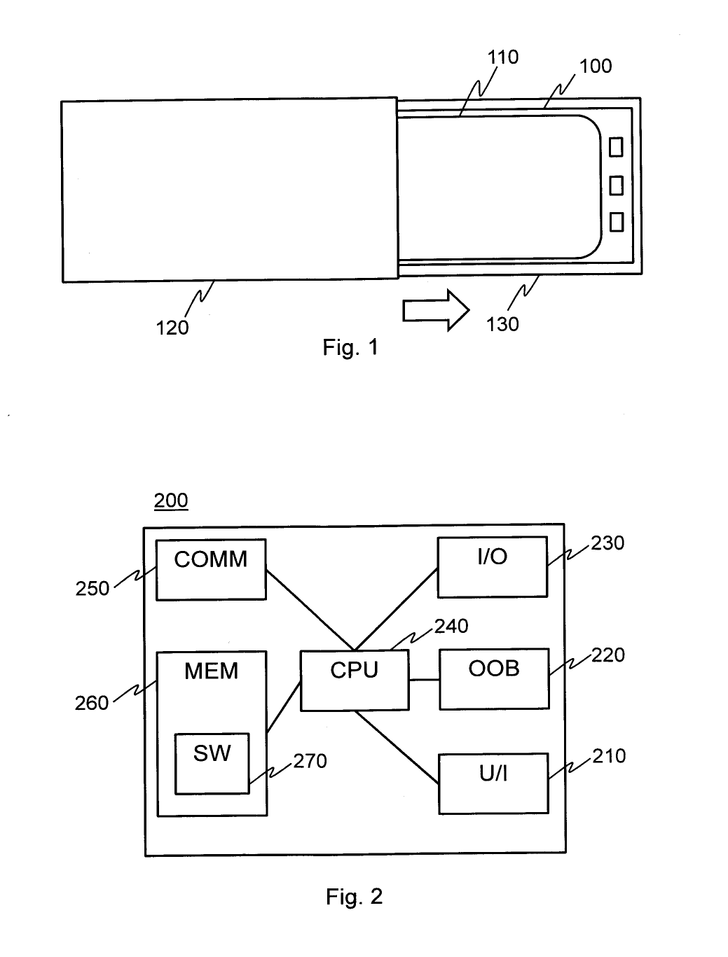

Some example embodiments of the present invention and potential advantages are understood by referring to FIGS. 1 through 7 of the drawings.

FIG. 1 shows an example of an environment in which example embodiments of the invention are applied. An electronic device 100, for example a smart phone, is placed in a sales package, i.e. a box, for retail sales. After purchase the new owner of the device 100 opens the package, for example by sliding the part 130 of the package supporting the device 100 out from inside a cover or sleeve portion 120. When the package is opened and the device 100 is accessible, the new owner, hereinafter referred to as the user, retrieves the device from the package in order to take it in use. The sales package is often also opened in a retail store for purposes of demonstrating the device 100.

Conventionally, the package contains therein or thereon instructions on how to start using the device, e.g. instructions for attaching a battery and/or for inserting a subscriber identity module (SIM)-card into the device. Such instructions are often cumbersome to use and the user is not necessarily immediately aware that the device is ready to be taken into action and enjoyed. The device 100 comprises a user interface device 110, for example a touch sensitive display that is used for guiding the user in taking the device into use after the device has been powered up. In order to provide an enhanced user experience, an out-of-box experience (OOBE), the user interface device is automatically used for providing guidance and enjoyment, i.e. information and instructions in pleasing format for taking the device in use. In an example embodiment, the out-of-box experience and the instructions provided therewith comprise media such as video, audio, text, figures or still images.

FIG. 2 shows a schematic a block diagram of an apparatus 200 of an example embodiment. The apparatus 200 is suited for operating as the device 100. The apparatus 200 comprises a communication interface module 250, a processor 240 coupled to the communication interface module 250, and a memory 260 coupled to the processor 240. The apparatus further comprises and input/output (I/O) unit 230, a user interface (U/I) unit 210, such as a touch sensitive display and an out-of-box unit 220, which are coupled to the processor 240.

The memory 260 comprises a work memory and a non-volatile memory such as a read-only memory, flash memory, optical or magnetic memory. In the memory 260, typically at least initially in the non-volatile memory, there is stored software 270 operable to be loaded into and executed by the processor 240. The software 270 may comprise one or more software modules and can be in the form of a computer program product that is software stored in a memory medium.

It shall be understood that any coupling in this document refers to functional or operational coupling; there may be intervening components or circuitries in between coupled elements unless expressly otherwise described.

The communication interface module 250 is configured to provide local communications over one or more local links. The links may be wired and/or wireless links. The communication interface 250 may further or alternatively implement telecommunication links suited for establishing links with other users or for data transfer, e.g. using the Internet. Such telecommunication links may be links using any of: wireless local area network links, Bluetooth, ultra-wideband, cellular or satellite communication links. The communication interface 250 may be integrated into the apparatus 200 or into an adapter or card that may be inserted into a suitable slot or port of the apparatus 200. While FIG. 2 shows one communication interface 250, the apparatus may comprise a plurality of communication interfaces 250. In a further example embodiment, the apparatus further 200 comprises a near field communication (NFC) unit.

The processor 240 is, for instance, a central processing unit (CPU), a microprocessor, a digital signal processor (DSP), a graphics processing unit, an application specific integrated circuit (ASIC), a field programmable gate array, a microcontroller or a combination of such elements. FIG. 2 shows one processor 240, but the apparatus 200 may comprise a plurality of processors.

As mentioned in the foregoing, the memory 260 may comprise volatile and a non-volatile memory, such as a read-only memory (ROM), a programmable read-only memory (PROM), erasable programmable read-only memory (EPROM), a random-access memory (RAM), a flash memory, a data disk, an optical storage, a magnetic storage or a smart card. In some example embodiments, only volatile or non-volatile memory is present in the apparatus 200. Moreover, in some example embodiments, the apparatus comprises a plurality of memories. In some example embodiments, various elements are integrated. For instance, the memory 260 can be constructed as a part of the apparatus 200 or inserted for example into a slot or a port. Further still, the memory 260 may serve the sole purpose of storing data, or it may be constructed as a part of an apparatus serving other purposes, such as processing data. Similar options are thinkable also for various other elements.

A skilled person appreciates that in addition to the elements shown in FIG. 2, the apparatus 200 may comprise other elements, such as microphones, displays, as well as additional circuitry such as a camera unit, further input/output (I/O) circuitries, memory chips, application-specific integrated circuits (ASIC), processing circuitry for specific purposes such as source coding/decoding circuitry, channel coding/decoding circuitry and ciphering/deciphering circuitry. Additionally, the apparatus 200 may comprise a disposable or rechargeable battery (not shown) for powering the apparatus if external power supply is not available.

It is also useful to realize that the term apparatus is used in this document with varying scope. In some of the broader claims and examples, the apparatus may refer to only a subset of the features presented in FIG. 2 or even be implemented without any one of the features of FIG. 2. In an example embodiment term apparatus refers to the processor 240.

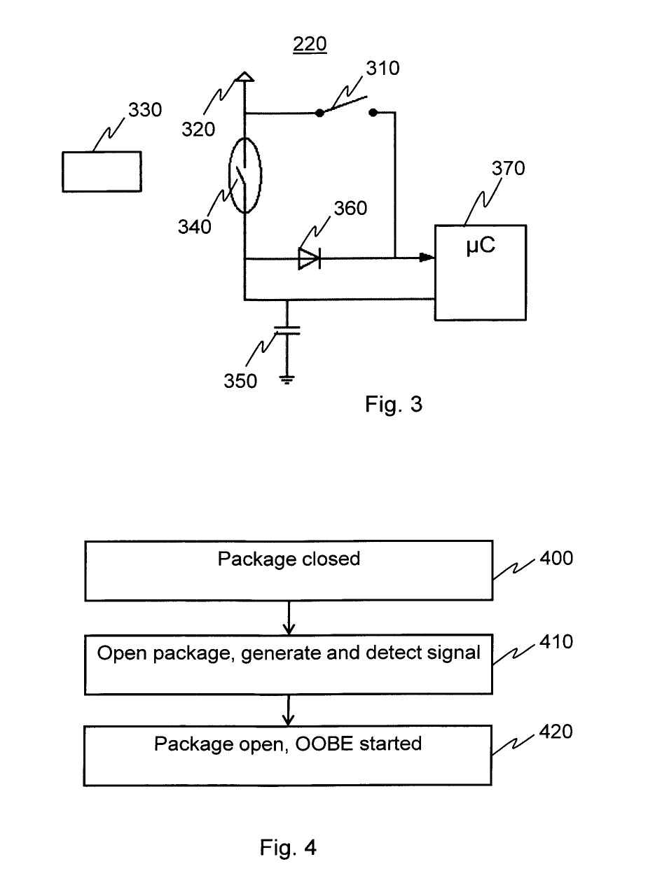

FIG. 3 shows a schematic circuit diagram of an out-of-box unit 220 according to an example embodiment of the invention. The out-of-box unit 220 is coupled to or integrated with the power button 310 of the apparatus 200. The out-of-box unit 220 further comprises a microcontroller 370. The microcontroller 370 is in an example embodiment a separate processor coupled to the processor 240, such as a processor of a type specified hereinbefore with reference to FIG. 1. In a further example embodiment, the microcontroller is a part of the processor 240, or the functionality thereof has been implemented in the processor 240.

In an example embodiment the out-of-box unit is connected 320 to an operating voltage, for example to the voltage provided by a battery, of the apparatus 200. The out-of-box unit 220 comprises a sensing element 340, for example a reed relay 340 responsive to a magnetic field, from a source 330, such as a permanent magnet, external to the apparatus 200, for example attached to the sales package in which the apparatus 200 resides prior to taking it into use. The sensing element 340 detects a signal from an external source 330 and closes the circuit, in an example embodiment, the circuit is closed while the reed relay 340 is in a magnetic field. In response to the sensing element 340 detecting the signal, the microcontroller 370 is powered up. The effect of the sensing element 340, e.g. the reed relay, closing the circuit is comparable to the effect of a user pushing the power button 310.

In an example embodiment, the microcontroller 370 comprises for example two inputs which the microcontroller is configured to check after powering up in order to determine whether the power button 310 has been pushed or the sensing element 340 has closed the circuit. A component, such as a diode 360, is comprised in the out-of-box unit for preventing the activation of the out-of-box experience when the power button has been pushed and the sensing element 340 has not closed the circuit. The out-of-box unit 220 further comprises a component, such as a capacitor 350, for providing a voltage to the input of the microcontroller 370 until the microcontroller is powered up, as the signal in response to which the sensing element 340 closed the circuit might not be present long enough for the microcontroller to power up and to determine whether the power button 310 has been pushed or the sensing element 340 has closed the circuit.

In an example embodiment, should the microcontroller determine that the sensing element has closed the circuit in response to a signal, an out-of-box experience is started. The microcontroller 370 and/or processor 240 are configured to carry out the steps of the out-of-box experience, for example to display information for the user on the touch sensitive display 210 of the apparatus 200. In a further example embodiment, the steps carried out in response to the sensing element closing the circuit and the detection thereof by the microcontroller are implemented by software for example stored in the memory of the apparatus 260 and executed by the processor 240 and/or the microcontroller 370.

In a further example embodiment, the out-of-box unit comprises, instead of e.g. a reed relay, an alternative arrangement as a sensing element, such as a relay, a switch or a sensor for activating the out-of-box experience. In an example embodiment, a mechanical switch is used in place of the reed relay. In a further example embodiment, a suitable photodiode is used instead or in addition to the reed relay and connected to the circuit in such a way that the diode allows the out-of-box experience start only when exposed to light, i.e. in the dark for example inside the sales package, the photodiode would prevent powering up the microcontroller.

In a further example embodiment, the out-of-box unit comprises instead or in addition to the reed relay 340, a sensor (not shown) for activating the out-of-box experience. The sensor comprises in an example embodiment a magnetic sensor, such as a hall sensor, for detecting an external magnetic field, or a light sensor, such as a photoresistor, phototransistor, or a photovoltaic cell. A skilled person appreciates that in such an embodiment conventional circuitry required by the sensor is comprised in the apparatus 200. In a further example embodiment, an additional sensor is used to verify that the out-of-box experience should start, i.e. that the apparatus 200 has been removed from the sales package or that the sales package is open, so that the apparatus 200 is exposed and it is intended that the out-of-box experience should start. If for example a light sensor detects that the apparatus 200 is still in the dark, the sequence for starting the out-of-box experience is aborted and the apparatus 200 is powered down. In a further example embodiment, the out-of-box experience can be started several times or repeatedly before the apparatus 200 has been fully taken into use. In an example embodiment, the out-of-box experience comprises a demonstration mode, for example for showing the capabilities of the apparatus in a retail store without taking the apparatus into use. In an example embodiment, an additional sensor is used as described hereinbefore to stop the out-of-box experience as the apparatus is returned to the sales package after demonstration.

In a further example embodiment the out-of-box experience is started with an element external to the apparatus 200. In an example embodiment, the sales package comprises an active unit, such as a near field communication (NFC) unit for powering up the microcontroller. A skilled person appreciates that in such an embodiment conventional circuitry required by the active element is comprised in the sales package.

In a further example embodiment, the power button 310 is implemented with software. In addition to the software implemented power button 310, the circuit for powering up the apparatus 200 with the power button 310 is mechanically broken by the reed relay 340, which substantially prevents any power leakage from occurring in the sales package.

In an example embodiment, after the out-of-box experience is concluded and the apparatus has successfully been taken into use, the functionality of the out-of-box unit 220 is disabled. Alternatively, the out-of-box unit is deactivated manually by the user, allowing for example the activation of the out-of-box experience for promotional purposes in retail sales. In a further example embodiment, the functionality is optionally reactivated by the user, e.g. for taking the device into use again after resetting. In a further example embodiment, the out-of-box unit 220 is used for other purposes after the out-of-box experience, e.g. for activating a different function of the apparatus 200 in response to a detected signal. In a further example embodiment, the function to be activated with the out-of-box unit 220 is chosen by the user, for example the user is able to specify that the apparatus should synchronize information stored in the memory 260 of the apparatus 200 with an external service in response to the signal being detected by the out-of-box unit. In such a case, the element generating the signal, for example the magnet, is located for example on a tabletop or in a dock, such as a wireless audio dock, or in a stylus used for or with the apparatus.

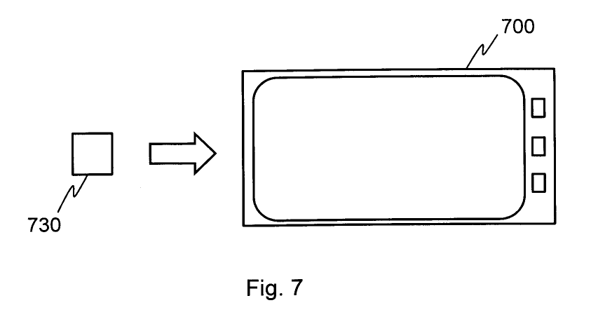

In a further example embodiment the out-of-box unit 220 is used to activate a function of the apparatus 200 that is subsequently configured to activate further functions. For example, the apparatus 200 comprises a near field communication (NFC) unit that requires battery power in an active mode and has a sleeping mode for saving power. In an example embodiment, the out-of-box unit 220 is configured to power up an NFC unit of the apparatus 200. With reference to FIG. 7, an element 730, such as a permanent magnet for activating the sensing element of the device 700, is placed in or in proximity of an NFC tag or a device, for example a wireless audio dock, wishing to communicate with the device 700 using near field communication. Accordingly, as the device 700 is brought into the proximity of the element 730 or the element 730 is brought into proximity of the device 700, the NFC unit of the device 700 is automatically activated without the user having to wake up the NFC unit manually.

FIG. 4 shows a flow chart of a method according to an example embodiment of the invention. At 400 the sales package is in a closed configuration and the apparatus 200 is enclosed therein. As the package is opened 410, a signal is generated and detected by the out-of-box unit 220. In response to the signal, the out-of-box unit powers up the apparatus 200 as hereinbefore and hereinafter described. A skilled person appreciated that the term signal encompasses any actuation, excitation or stimulus that is detected by the out-of-box unit 220 or an element comprised therein. In an example embodiment, the signal is an external magnetic field from a magnet 330 or light as hereinbefore described. At 420, the sales package is open and the out-of-box experience starts or is started.

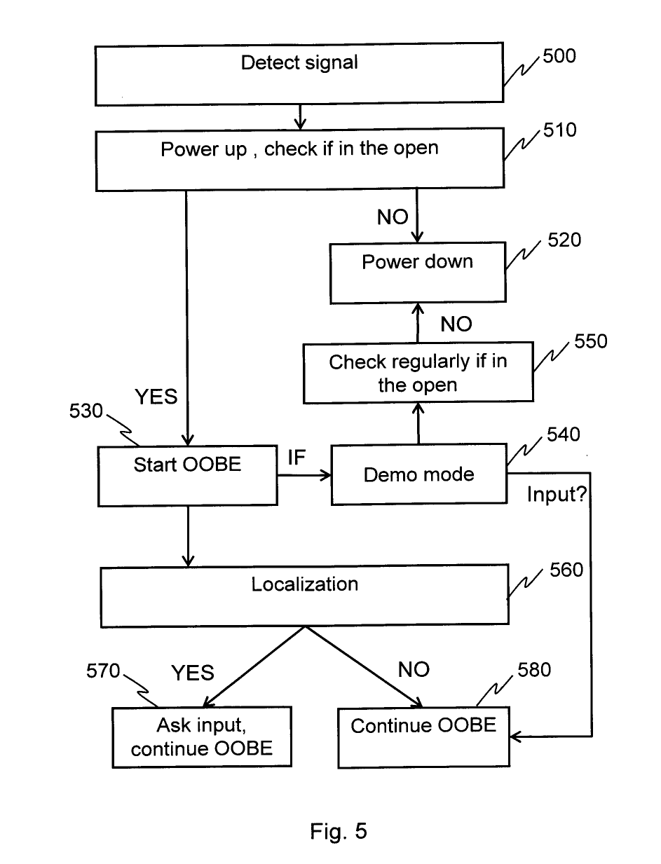

FIG. 5 shows a flow chart of a method according to an example embodiment of the invention. At 500 the out-of-box unit 220 or an element thereof, such as the reed relay 340, detects a signal such as an external magnetic field of the magnet 330. At 510 the out-of-box unit 220 powers up the apparatus 200 as hereinbefore described. In an example embodiment the out-of-box unit 220 or the apparatus 200 checks or verifies whether the apparatus 200 is in the open, i.e. exposed in the package or removed from the package e.g. by using a light sensor or other units of the apparatus 200, such as an acceleration sensor comprised therein. At 520, if the apparatus 200 is not exposed, the sequence for starting the out-of-box experience is aborted and the apparatus 200 is powered down. At 530, the apparatus 200 is exposed and the out-of-box experience is automatically started. In an example embodiment, the out-of-box experience includes localization, for example the choice of a language. In such a case, the out-of-box experience is started and after a while at 560 the user is asked for input 570 on the touch sensitive display 210 of the apparatus 200, for example the user is asked to choose a language, before the out-of-box experience is continued. If no localization is required, the out-of-box experience continues uninterrupted at 580.

In a further example embodiment, the out-of-box experience comprises a demonstration, or demo, mode as hereinbefore described. Accordingly, if the out-of-box experience comprises a demo mode 540, at 550 the apparatus 200 checks or verifies regularly, e.g. at every minute, whether the apparatus 200 is in the open, i.e. exposed in the package or removed from the package e.g. by using a light sensor or other units of the apparatus 200, such as an acceleration sensor comprised therein. At 520, if the apparatus 200 is not exposed 200, the sequence for starting the demonstration mode of the out-of-box experience is stopped and the apparatus 200 is powered down. In a further example embodiment, at demonstration mode, the user can provide input e.g. via the touch sensitive display to move away from the demonstration mode and continue 580 the out-of-box experience including the taking into use of the apparatus 200.

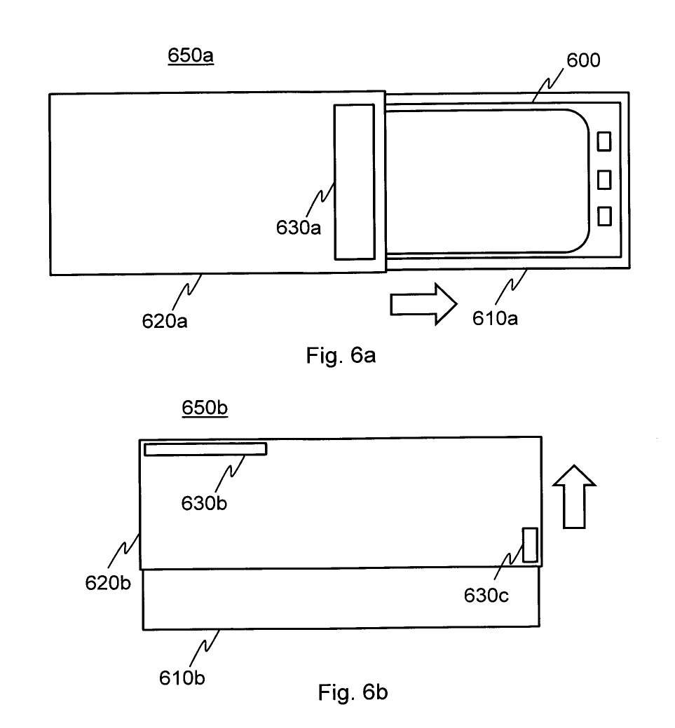

FIGS. 6a and 6b show schematic views of sales packages according to example embodiments. In an example embodiment, the sales packages 650a,650b comprise a first part 610a,610b, e.g. a box, configured to support the apparatus 600 in the sales package. The sales packages 650a,650b comprise a second part 620a,620b, such as a sleeve or a lid, configured to fit on or around the first part 610a,610b to close the sales package 650a,650b and enclose the apparatus 600 therein. The first part 610a,610b and the second part 620a,620b are configured to be movable, e.g. by sliding, lifting or drawing out, relative to each other for opening and closing the sales package 650a,650b. The second part 620a,620b comprises an element 630a-c, e.g. a permanent magnet, configured to generate and/or provide a signal for an out-of-box unit of the apparatus 600 as herein before described. The element 630a-c is positioned in or on the second part 620a,620b in such a way as to generate and/or provide the signal during the opening of the sales package, i.e. as the first part 610a,610b and the second part 620a,620b are moved relative to each other from a closed position to an open position. In an example embodiment, the element 630a-c is positioned in such a way as to come into the proximity of the out-of-box unit, or be removed from the proximity thereof, of the apparatus 600 when the sales package is almost completely open.

In a further example embodiment, the sales package has different form, i.e. a further form conventional for a sales package, for example the first and second parts are connected to each other, and the sales package is opened by moving the second part in a manner of a hinged lid. A skilled person appreciates that in a further example embodiment, the sales package comprises further parts or elements, such as further parts enclosing and/or supporting the product or parts thereof, and/or elements such as a wrapper, price tags or information stickers. In a further example embodiment, the sales package has a still different form, for example the apparatus or product enclosed therein is enclosed in a one-piece plastic shell, i.e. the first and second part are connected to each other and movable relative to each other only by breaking the structure of the sales package. In such a case, the signal is generated and/or provided as the sales package is opened in a conventional manner, for example as the sales package is moved from a closed position to an open position by ripping off the shell enclosing the product.

Without in any way limiting the scope, interpretation, or application of the claims appearing below, a technical effect of one or more of the example embodiments disclosed herein is that an electronic device is taken into use faster and more easily. Another technical effect of one or more of the example embodiments disclosed herein is an enhanced and enjoyable user experience on purchase. Another technical effect of one or more of the example embodiments disclosed herein to provide an easy and power saving way of waking up active devices that are put to power saving mode.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A package comprising:
a first part configured for supporting an electronic device;
a second part configured to fit on or around the first part for closing the package and enclosing the electronic device therein; wherein
the first part and the second part are configured to be movable relative to each other from a closed position to an open position; and wherein
the package comprises an element for generating a signal in response to the first part and the second part being moved from the closed position to the open position.

2. The package of claim 1, wherein the element for generating the signal comprises a permanent magnet.

3. The package of claim 1, wherein the element for generating the signal comprises a near field communication, NFC, unit.

4. An apparatus comprising:
a display;
a processor; and
a sensing element; wherein
the processor is configured to cause
detecting a signal with the sensing element;
powering up the apparatus in response to the signal; and
automatically displaying information on the display.

5. The apparatus of claim 4, wherein the sensing element comprises a reed relay.

6. The apparatus of claim 4, wherein the sensing element comprises a mechanical switch.

7. The apparatus of claim 4, wherein the sensing element comprises an optical sensor.

8. The apparatus of claim 4, wherein the sensing element comprises a magnetic sensor.

9. The apparatus of claim 4, wherein the display comprises a touch sensitive display.

10. The apparatus of claim 4, wherein the processor is further configured to cause, subsequent to powering up the apparatus, verifying that the powering up was intended.

11. The apparatus of claim 4, wherein the processor is further configured to cause, subsequent to displaying the information, disabling the sensing element.

12. The apparatus of claim 4, wherein the processor is further configured to cause activating a function of the apparatus in response to the signal.

13. The apparatus of claim 4, wherein the apparatus comprises an electronic device.

14. The apparatus of claim 4, wherein the apparatus comprises a smartphone or a mobile phone.

15. A method comprising:
moving a first part and a second part of a package relative to each other from a closed position to an open position; and
generating a signal in response to the first part and the second part being moved from the closed position to the open position.

16. The method of claim 15, wherein the signal is generated with a permanent magnet.

17. The method of claim 15, wherein the signal is generated with a near field communication, NFC, unit.

18. A method comprising:
detecting a signal with a sensing element;
powering up an apparatus in response to the signal; and
automatically displaying information on a display of the apparatus.

19. The method of claim 18, wherein the sensing element comprises a reed relay.

20. The method of claim 18, wherein the sensing element comprises a mechanical switch.

21. The method of claim 18, wherein the sensing element comprises an optical sensor.

22. The method of claim 18, wherein the sensing element comprises a magnetic sensor.

23. The method of claim 18, wherein the display comprises a touch sensitive display.

24. The method of claim 18, further comprising, subsequent to powering up the apparatus, verifying that the powering up was intended.

25. The method of claim 18, further comprising, subsequent to displaying the information, disabling the sensing element.

26. The method of claim 18, further comprising activating a function of the apparatus in response to the signal

27. The method of claim 18, wherein the apparatus comprises an electronic device.

28. The method of claim 18, wherein the apparatus comprises a smartphone or a mobile phone.

29. A system comprising:
a package comprising
a first part configured for supporting an apparatus;
a second part configured to fit on or around the first part for closing the package and enclosing the apparatus therein; wherein
the first part and the second part are configured to be movable relative to each other from a closed position to an open position; and
wherein
the package comprises an element for generating a signal in response to the first part and the second part being moved from the closed position to the open position; wherein
the apparatus comprises
a display;
a processor; and
a sensing element; wherein
the processor is configured to cause
detecting the signal with the sensing element;
powering up the apparatus in response to the signal; and
automatically displaying information on the display.

30. The system of claim 29, wherein the element for generating the signal comprises a permanent magnet.

31. The system of claim 29, wherein the element for generating the signal comprises a near field communication, NFC, unit.

32. The system of claim 29, wherein the sensing element comprises a reed relay.

33. The system of claim 29, wherein the sensing element comprises a mechanical switch.

34. The system of claim 29, wherein the sensing element comprises an optical sensor.

35. The system of claim 29, wherein the sensing element comprises a magnetic sensor.

36. The system of claim 29, wherein the display comprises a touch sensitive display.

37. The system of claim 29, wherein the processor is further configured to cause, subsequent to powering up the apparatus, verifying that the powering up was necessary.

38. The system of claim 29, wherein the processor is further configured to cause, subsequent to displaying the information, disabling the sensing element.

39. The system of claim 29, wherein the apparatus comprises an electronic device.

40. The system of claim 29, wherein the apparatus comprises a smartphone or a mobile phone.

41. A method comprising:
moving a first part and a second part of a package relative to each other from a closed position to an open position;
generating a signal in response to the first part and the second part being moved from the closed position to the open position;
detecting a signal with a sensing element;
powering up an apparatus in response to the signal; and
automatically displaying information on a display of the apparatus.

42. The method of claim 41, wherein the signal is generated with a permanent magnet.

43. The method of claim 41, wherein the signal is generated with a near field communication, NFC, unit.

44. The method of claim 41, wherein the sensing element comprises a reed relay.

45. The method of claim 41, wherein the sensing element comprises a mechanical switch.

46. The method of claim 41, wherein the sensing element comprises an optical sensor.

47. The method of claim 41, wherein the sensing element comprises a magnetic sensor.

48. The method of claim 41, wherein the display comprises a touch sensitive display.

49. The method of claim 41, further comprising, subsequent to powering up the apparatus, verifying that the powering up was necessary.

50. The method of claim 41, further comprising, subsequent to displaying the information, disabling the sensing element.

51. The method of claim 41, wherein the apparatus comprises an electronic device.

52. The method of claim 41, wherein the apparatus comprises a smartphone or a mobile phone.

53. A computer program product comprising computer code for causing performing the method of claim 15, when executed by an apparatus.

54. A memory medium comprising the computer program of claim 53.

55. A computer program product comprising computer code for causing performing the method of claim 18, when executed by an apparatus.

56. A memory medium comprising the computer program of claim 55.

57. A computer program product comprising computer code for causing performing the method of claim 41, when executed by an apparatus.

58. A memory medium comprising the computer program of claim 57.
